(19) United States
(12) Patent Application Publication
(10) Pub. No.: US 2003/0024178 A1
(43) Pub. Date: Feb. 6, 2003

(54) Stabilized window structures and methods for stabilizing and removing shattered window panes

(76) Inventor: Jeffrey H. Diamond, Palm Beach, FL (US)

Correspondence Address: Robert H. Epstein, Epstein, Edell, Shapiro, Finnan & Lytle, LLC, 1901 Research Blvd., Suite 400, Rockville, MD, 20850, US

(21) Appl. No.: 09/920,750

(22) Filed: Aug. 3, 2001

(51) Int. Cl. B05D 1/00

(52) U.S. Cl. 52/202; 52/309.8; 427/154; 427/244; 52/514

(57) ABSTRACT

A stabilized window structure includes a window frame, a shattered window pane disposed in the window frame, and a layer of unifying material bonded to the window pane to form a cohesive mass removable from the frame as one or more integral and unitary pieces. A method of stabilizing and removing a shattered window pane from a window frame includes the steps of applying a layer of unifying material to an exterior surface and/or an interior surface of the shattered window pane, bonding the layer of unifying material to the window pane to form a cohesive mass therewith, and removing the cohesive mass from the window frame as one or more integral and unitary pieces.

### BACKGROUND OF THE INVENTION

1. Field of the Invention

The present invention generally relates to stabilizing and safely removing shattered panes of window structures. More particularly, the present invention relates to the application of a layer of polymeric material to a shattered pane of a window structure to form the shattered pane into a stabilized, cohesive mass permitting safe removal of the shattered pane.

2. Brief Discussion of the Related Art

Window structures are found in many various types of fabrications or constructions including buildings and vehicles, such as automobiles, buses, trains, planes, boats and the like. Conventional window structures include one or more transparent window panes, typically made of glass or other breakable material, and a frame, which may be formed by a separate frame member or by a portion of the fabrication or construction itself, supporting the one or more panes. The panes of most window structures are susceptible to damage from many various sources; and, consequently, shattering, breaking or cracking of window panes is not uncommon. A window structure in which a pane is shattered, broken or cracked is unstable since the damaged pane is prone to collapse or cave in, loose fragments or shards may fall or come loose from the pane, and the seal normally provided by the unbroken pane between the exterior and interior sides thereof is compromised. Fragments that actually fall or come loose from the pane present the risks of injury to individuals and damage to objects located exteriorly and/or interiorly of the window structure, particularly since the panes of window structures are most commonly made of glass. Compromise of the seal normally provided by the unbroken window pane presents the risk that the interior side will be undesirably exposed to environmental elements via cracks, fractures, fissures and/or holes in the pane. Accordingly, there is often a great sense of urgency to remove and replace shattered window panes immediately to eliminate the hazards presented when they are left in place for some time.

The instability presented by a window structure having a shattered window pane makes safe removal of the pane difficult to accomplish. One common approach used by professional glass companies to remove shattered glass panes of window structures involves smashing the panes with a hammer or other implement so that they fall to the exterior of the fabrications or constructions in which the window structures are installed. This approach tends to scatter glass fragments, and even tempered or laminated glass can produce many small fragments. When the glass fragments impact the ground or other objects, they may shatter even further and may damage the objects impacted thereby. Afterwards, significant additional labor is required for clean-up to collect and remove the glass fragments. Even when great care is exercised, however, potentially injurious glass fragments may be left behind due to the great difficulty associated with collecting small and/or widely scattered glass fragments.

Another approach to dealing with shattered glass panes of window structures attempts to stabilize the window structures prior to removal of the panes. With this approach, the shattered glass panes are taped with adhesive tape to hold the panes together prior to removing them from the fabrications or constructions in which the window structures are installed. In order to keep a shattered glass pane intact, the adhesive tape must typically be applied to the entire or substantially the entire surface of the shattered glass pane. Applying the adhesive tape to the entire or substantially the entire surface of the shattered glass pane is laborious and time consuming, particularly where the glass pane is large. In addition, the tape must be pressed against the shattered pane in order to adhere the tape thereto, and such pressure or force can cause the pane to cave in or collapse and/or fragments to come loose therefrom. Even when the adhesive tape is carefully applied to the entire surface of the glass pane, fragments may still become detached from the tape and fall when the shattered pane is manipulated during removal.

In vehicles, the panes of window structures, such as windshields, sliding windows, fixed windows and movable windows, are oftentimes shattered, cracked or broken due to impacts, such as those incurred during vehicular collisions or crashes. Where one or more passengers are trapped inside a vehicle, such as when the doors of the vehicle cannot be opened, it is often necessary to quickly remove a window pane to access the one or more passengers. In the case of automobiles, for example, it is often necessary to quickly remove a shattered front and/or rear windshield in order to access one or more passengers trapped inside. In emergency situations where one or more trapped passengers may be injured and require medical attention, reducing the time required to remove a vehicle window pane to access the one or more passengers is of the essence.

It is undesirable to remove broken window panes of vehicles by pushing the panes into the interior of the vehicles. The latter approach is particularly undesirable where one or more passengers are trapped inside the vehicle, since the one or more passengers may be injured by fragments of the pane during and subsequent to entry of the fragments into the vehicle interior. An approach that has been used in emergency situations to remove shattered car windows involves applying adhesive tape to the exterior surface of a shattered window pane in order to enhance the integrity of the shattered window pane so that paramedics can pull it out of the car. As pointed out above, this procedure is usually time consuming and may cause the shattered window pane to cave in or collapse. The time that must be spent taping the shattered window pane represents time that an injured passenger goes untreated. In addition, caving or collapsing of the window pane into the vehicle interior may cause injury to the passengers therein.

The use of polymeric materials applied to glass for removal by peeling has been proposed, as represented by U.S. Pat. No. 3,455,865 to Bolt et al, U.S. Pat. No. 3,486,918 to Motter, U.S. Pat. No. 4,636,543 to Helton, U.S. Pat. Nos. 5,020,288 and 5,107,643 to Swenson, U.S. Pat. No. 5,143,949 to Grogan et al, U.S. Pat. No. 5,281,436 to Swidler, and U.S. Pat. Nos. 5,186,978, 5,302,413, 5,362,786, 5,411,760 and 5,523,117 to Woodhall et al. U.S. Pat. No. 3,830,760 to Benngston and U.S. Pat. No. 4,596,725 to Kluth et al are illustrative of one-component and two-component polyurethanes. None of the aforementioned patents contemplates the application of a layer of polymeric material to a shattered window pane to form the shattered pane into a cohesive mass allowing safe removal of the shattered pane from the fabrication or construction in which it is installed.

From the above, it should be appreciated that there is a great need for stabilized window structures and methods for stabilizing and removing shattered panes of window structures wherein shattered window panes can be controllably removed as one or more relatively large pieces of a cohesive, integral mass. The need further exists for stabilized window structures and methods for stabilizing shattered panes of window structures wherein shattered window panes are stabilized prior to removal without the application of significant pressure or force to the panes. The need also exists for stabilized window structures and methods for stabilizing and removing shattered panes of window structures that are safe, efficient, easy to use, economical, and applicable to various types and sizes of windows installed in various diverse fabrications or constructions.

### SUMMARY OF THE INVENTION

Accordingly, it is a primary object of the present invention to overcome the aforementioned disadvantages of prior approaches to stabilizing and/or removing shattered panes of window structures.

Another object of the present invention is to remove a shattered pane of a window structure as one or more relatively large pieces of a cohesive mass.

A further object of the present invention is to stabilize a shattered pane of a window structure by forming the shattered pane into a cohesive mass without exerting significant pressure on the shattered pane which might cause the pane to collapse and/or fragments to become loose therefrom.

An additional object of the present invention is to seal cracks, fractures and/or holes in a shattered pane of a window structure.

It is also an object of the present invention to adapt a shattered pane of a window structure for removal as one or more integral pieces of a cohesive mass from which fragments cannot become loose.

The present invention has as another object to apply a layer of unifying material to a shattered pane of a window structure to form the shattered pane into a unified mass.

Yet a further object of the present invention is to safely and easily restore structural integrity to a shattered pane of a window structure prior to and during removal of the shattered pane.

Some of the advantages of the present invention are that the risk of injury and/or damage presented by shattered window panes is greatly reduced; shattered panes of window structures can safely remain in place for some time prior to removal; the seal that is compromised in shattered panes of window structures can be substantially or fully restored while the shattered panes are left in place; shattered panes of window structures can be stabilized and/or removed in substantially less time and with substantially less labor than that required for other stabilizing and removal procedures; the unifying material is easy to apply to the shattered pane with only negligible pressure or force being exerted on the pane; formation of the cohesive or unified mass may be achieved in only a short time after the unifying material is applied so that a shattered pane can be stabilized and removed quickly in one procedure, if desired; the unifying material may be used for the stabilization and removal of shattered panes in emergency situations, such as where a shattered automobile window must be removed to extricate and/or access a passenger; the weight of the unifying material on the window pane is insubstantial; the composition/compositions for the unifying material can be stored in small containers prior to use; the composition/compositions may be provided with a long shelf life; the unifying material can be applied to a shattered pane by one person; the unifying material may be translucent so that light may pass therethrough; the unifying material may be applied to the exterior surface and/or the interior surface of a shattered pane; enhanced stabilization and protection may be achieved by applying the unifying material to both the exterior and interior surfaces of a shattered pane; and, the unifying material will not lose its shape or protective qualities when exposed to environmental elements such as rain.

The present invention is generally characterized in a stabilized window structure including a window frame, a shattered window pane disposed in the frame, and a layer of unifying material bonded to an exterior surface and/or an interior surface of the window pane to form the shattered pane into a cohesive mass. The unifying material may be a polymeric material, such as foam and non-foam polymeric materials, a cellulosic material or any other material capable of unifying the shattered pane into a cohesive mass. The unifying material is applied to the exterior surface and/or the interior surface of the window pane as a layer of sufficient uniform or non-uniform thickness to structurally unite the shattered pane. The unifying material may be applied to the window pane in fluidic form, and dries, cures, sets or hardens to form the cohesive mass. The cohesive mass, which includes the shattered pane and the layer of unifying material permanently or substantially permanently bonded thereto, is removable from the window frame as a single, integral piece or as a plurality of integral pieces without separation of the window pane from the layer of unifying material. The stabilized window structure may include one or more grasping members, such as handles, attached to the cohesive mass for grasping. The one or more grasping members may be attached to the cohesive mass by inserting or embedding one or more portions of the one or more grasping members in the layer of unifying material before the unifying material dries, cures, sets or hardens. Accordingly, upon the unifying material drying, curing, setting or hardening, the one or more portions of the one or more grasping members are bonded or adhered to the cohesive mass so that the one or more grasping members may be used to manually pull the cohesive mass from the window frame.

The present invention is further generally characterized in an alternative stabilized window structure including a window frame, a window pane disposed in the frame and having a hole therein, a first layer of unifying material adhered to the window pane around the hole, a patch covering the hole and adhered to the first layer of unifying material, and a second layer of unifying material applied over the patch and forming a cohesive mass with the patch, the first layer of unifying material and the window pane. The patch is preferably larger than the hole so that the hole is completely covered thereby. The second layer of unifying material may be applied over the entire or less than the entire surface area of the patch, but is preferably applied over at least the periphery of the patch and, more preferably, over the entire surface area of the patch, so that the patch is sealed. The hole in the window pane is thusly closed off and sealed, and the cohesive mass may be removed from the window frame without separation of the window pane from the unifying material.

The present invention is also generally characterized in a method of stabilizing and removing a shattered window pane from a window frame. The method comprises the steps of applying a layer of unifying material to an exterior surface and/or an interior surface of the shattered window pane, bonding the layer of unifying material to the shattered window pane to form a cohesive mass including the shattered window pane and the layer of unifying material bonded thereto, and removing the cohesive mass from the window frame as one or more integral and unitary pieces. The unifying material may be applied, such as by spraying, in fluidic form, and the fluidic unifying material may enter or seep into one or more cracks, fissures or holes in the shattered window pane. The unifying material dries, cures, sets or hardens to form the cohesive mass. The layer of unifying material may be applied to the window pane as a plurality of sub-layers. The layer of unifying material may be applied to substantially the entirety of the exterior surface and/or the interior surface exposed by the frame. One or more grasping members may be attached to the cohesive mass, and the one or more grasping members may be attached using the unifying material as an adhesive or bonding agent. The cohesive mass may be removed by manually pulling and/or pushing the cohesive mass to the exterior or to the interior of the window frame.

The present invention is further generally characterized in a method of stabilizing a window pane having a hole therein. The method comprises the steps of applying a first layer of unifying material to an exterior surface and/or an interior surface of the window pane around the hole, positioning a patch over the hole to contact the first layer of unifying material; bonding the first layer of unifying material to the window pane and the patch, applying a second layer of unifying material over at least the periphery of the patch, and bonding the second layer of unifying material to the patch such that the hole is closed off and sealed.

Other objects and advantages of the present invention will become apparent from the following description of preferred embodiments taken in conjunction with the accompanying drawings wherein like parts in each of the several figures are identified by the same reference characters.

### BRIEF DESCRIPTION OF THE DRAWINGS

FIG. 1 is a broken, front perspective view of a building including a window structure having a shattered pane and showing a layer of unifying material being applied to an exterior surface of the shattered pane.

FIG. 2 is a broken, front perspective view of the building of FIG. 1 subsequent to application of the layer of unifying material to the shattered pane to form the shattered pane into a cohesive mass.

FIG. 3 is a broken cross-sectional view of the window structure taken along line 3-3 of FIG. 2.

FIG. 4 is an enlarged, fragmentary cross-sectional view of the cohesive mass illustrating seepage of the unifying material into a crack of the shattered pane.

FIG. 5 is a broken, front perspective view of the building of FIG. 2 illustrating removal of the shattered pane with the cohesive mass.

FIG. 6 is a broken cross-sectional view of a window structure illustrating an alternative layer of unifying material applied to a shattered pane of the window structure.

FIG. 7 is a broken cross-sectional view of a window structure showing layers of unifying material applied to the exterior and interior surfaces, respectively, of a shattered pane of the window structure, with one of the layers including a plurality of sub-layers.

FIG. 8 is a schematic view illustrating use of a two-component supply system in the present invention.

FIG. 9 is a broken, front perspective view of a building including a window structure having a shattered pane with a hole therein and showing a first layer of unifying material being applied to the pane around the hole.

FIG. 10 is a broken, front perspective view of the building of FIG. 9 showing a patch applied over the hole and being adhered by the first layer of unifying material.

FIG. 11 is a broken, front perspective view of the building of FIG. 10 illustrating a second layer of unifying material being applied over the patch to seal the hole in the pane.

FIG. 12 is a broken, front perspective view of an automobile having a shattered windshield to which a layer of unifying material has been applied to form a cohesive mass and illustrating the shattered windshield being manually held via handles attached to the cohesive mass.

FIG. 13 is a broken, front perspective view of the automobile of FIG. 12 illustrating removal of the shattered windshield with the cohesive mass.

### DESCRIPTION OF THE PREFERRED EMBODIMENTS

The present invention relates to the application of a layer of unifying material to shattered, cracked or broken panes of window structures installed in fabrications or constructions such as buildings and vehicles. The present invention may be used on window structures of any type including one or more panes disposed in an opening of the fabrication or construction and mounted in a window frame circumscribing the opening. The panes may be flat or planar or may have curved or other non-planar shapes or profiles. The window frame may be constructed separately from the fabrication or construction as a frame member including one or more parts, or may be formed integrally, unitarily with the fabrication or construction. As an example of the latter, the frame may be formed by the peripheral edge or border created by the opening in the fabrication or construction, and this edge or border can be provided with or without a trim or finish. Representative window structures include sash windows, casement windows, sliding glass doors, slidably or pivotally movable windows, non-movable windows, protruding windows and recessed windows in buildings, and windshields, sliding windows, fixed windows, and movable windows in vehicles. Fabrications and constructions to which the present invention applies may be commercial or residential. The one or more panes will typically be made of glass, but may be made of any material susceptible to being shattered, broken or cracked. Accordingly, the description of a glass pane in the following embodiments should be considered illustrative only. In addition, as used herein “glass” is intended to include various types of glass including treated glass, untreated glass, tempered glass, laminated glass, single pane glass, double pane glass, etc.

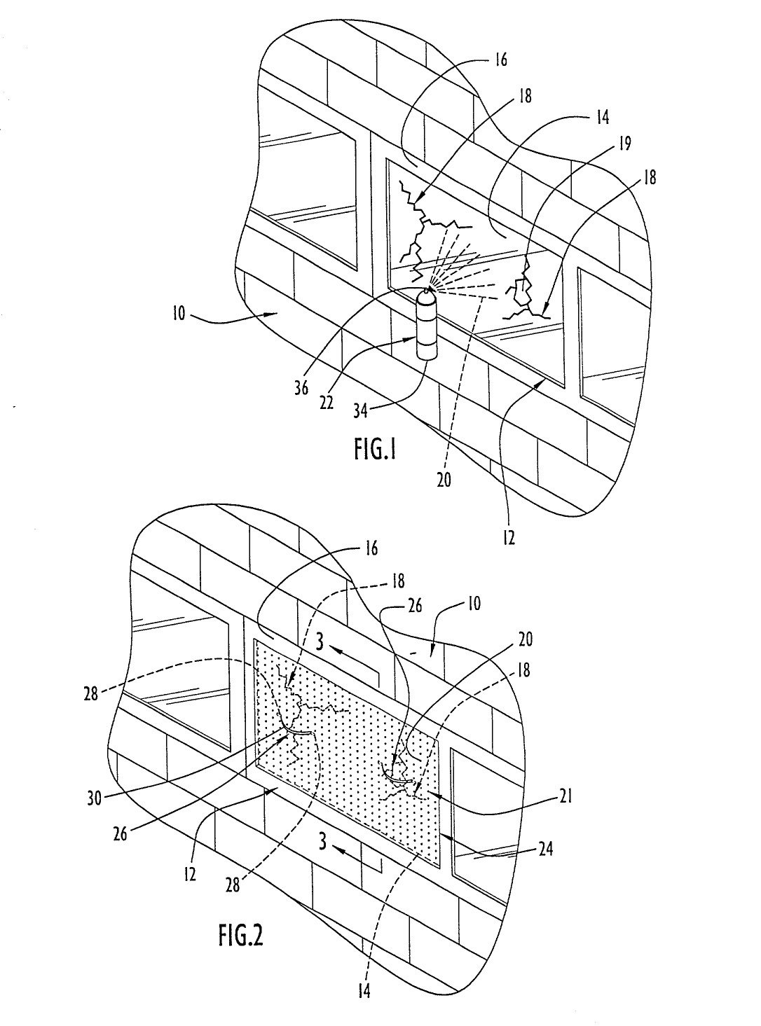

FIG. 1 illustrates a building 10 having a window structure 12 including a glass window pane 14 mounted in a window frame 16. The window pane 14 is planar and is disposed in an opening of the building 10, with the frame 16 circumscribing the opening. The window pane 14 is shattered, broken or cracked, and has one or more cracks, fissures or fractures 18 therein. Depending on the severity of damage, the one or more cracks 18 may have broken the window pane 14 into individual fragments as shown by fragment 19. Fragment 19 has not yet fallen or otherwise become removed from the remainder of the window pane 14, but is at risk of falling or otherwise becoming removed from the remainder of the window pane so as to leave a hole therein, particularly if force or pressure is applied to the window pane. Even where the damage to the window pane 14 has produced cracks without individual fragments, the shattered window pane 14 is nonetheless susceptible to collapsing or caving in due to its own weight and/or extraneous force or pressure thereon. The one or more cracks 18 also compromise the seal normally provided by the window structure 12 when the window pane 14 is unbroken. The one or more cracks 18 permit communication between the exterior and the interior sides of the window structure 12 such that environmental elements may reach the building interior. Accordingly, the window structure 12 shown in FIG. 1 may be considered unstable due to compromise of the structural integrity and seal normally provided when the window pane 14 is not shattered, cracked or broken.

In accordance with the present invention, the window structure 12 is stabilized by applying a layer of unifying material to the shattered window pane 14 to adhere thereto and form the shattered pane into a cohesive mass. FIG. 1 illustrates a polymeric unifying material 20 being applied in fluidic form to the exterior surface of the window pane 14 over cracks 18. However, the polymeric material may be applied to the exterior surface and/or the interior surface of the window pane 14 depending on the location of the window structure, the accessability of the window structure, the extent of damage to the window pane and/or other factors. The polymeric material 20 may be applied to the window pane 14 in any manner, but is preferably sprayed on the window pane as shown in FIG. 1 so that the force or pressure exerted on the window pane during the application process is minimized. When the polymeric material 20 is sprayed on the window pane 14 as shown in FIG. 1, the force or pressure exerted on the window pane is negligible such that the fragment 19 does not become loose and the window pane does not collapse or cave in. Depending on the location and accessibility of the window structure 12, the polymeric material 20 can be sprayed from a hand-held spraying device 22 or from a remotely controlled spraying device mounted on an extendable pole or handle.

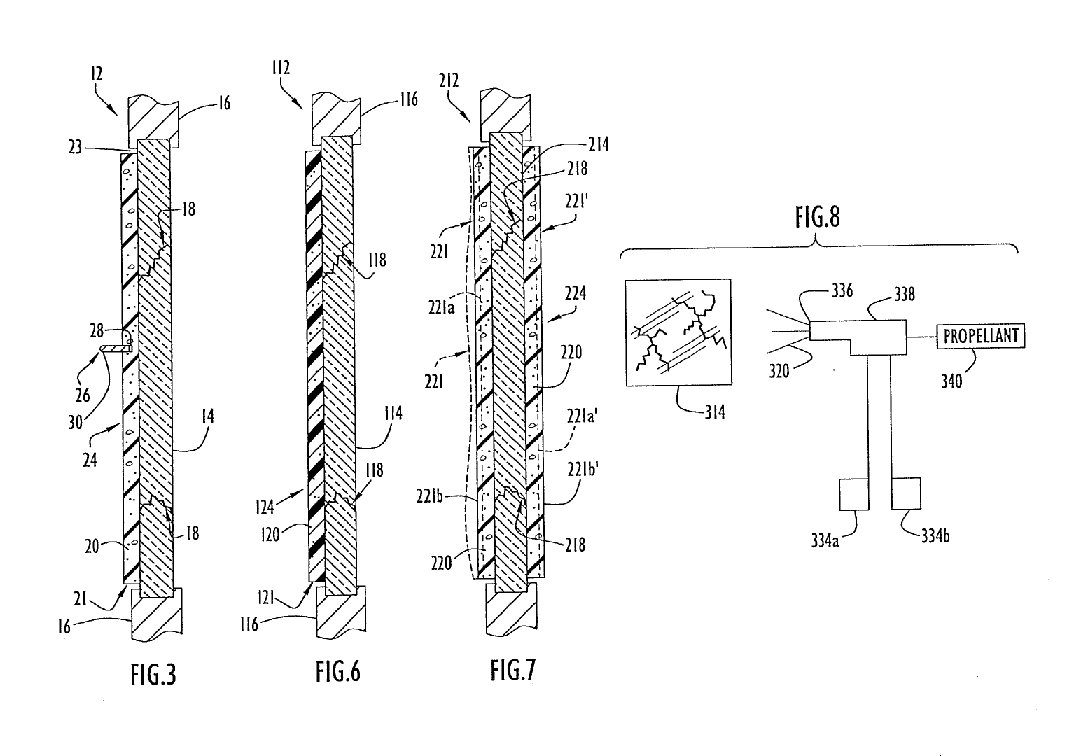

The polymeric material 20 is applied to the window pane 14 in a layer 21, as shown in FIGS. 2 and 3. Preferably, the layer 21 of polymeric material 20 is applied to the entire or substantially the entire surface area of the window pane exterior surface and/or interior surface exposed by frame 16 and selected to receive the layer of polymeric material. However, depending on the damage to the window pane, the layer of polymeric material may be applied to only a cracked, broken or shattered section or sections of the window pane and may thusly be applied to only a selected portion or portions of the window pane exterior surface and/or interior surface corresponding to the cracked, broken or shattered section or sections. The layer 21 of polymeric material may be applied to a desired thickness sufficient to structurally unite the shattered pane into a cohesive mass as explained further below. Typical thicknesses may be in the range of ⅛ inch to one inch thick or more, with layers of greater thickness typically being used on window panes of relatively greater thickness and/or external size. In an illustrative procedure, a layer of polymeric foam ¾ inch thick was found sufficient for a shattered glass pane ⅜ inch thick. The thickness of layer 21 may be uniform or non-uniform. Depending on the width of cracks 18, the fluidic polymeric material may seep into or enter one or more of the cracks 18, and the polymeric material may seep into one or more cracks the entire or less than the entire depth of the one or more cracks corresponding to the thickness of window pane 14. Accordingly, the fluidic polymeric material may seep into one or more cracks 18 so that fragments or shards, such as fragment 19, of pane 14 are embedded in the polymeric material. The fluidic polymeric material may seep into one or more cracks 18 the entire or less than the entire depth of the cracks between the exterior surface and the interior surface of window pane 14.

FIGS. 1-3 are representative of a stabilized window structure and stabilizing procedure wherein the layer 21 of polymeric material 20 is applied to substantially the entire surface area of the exterior surface of window pane 14 exposed by frame 16. FIGS. 2 and 3 show the layer 21 of polymeric material 20 applied to window pane 14 inside of frame 16 without any overlap of the layer 21 of polymeric material on the frame 16. In order to ensure that no polymeric material is applied over frame 16, a small peripheral gap 23 may be maintained during the application process between the frame 16 and the perimeter of the layer 21 as shown in FIG. 3. Avoiding overlap of the frame 16 by the layer 21 of polymeric material 20 ensures that the layer of polymeric material does not bond or adhere to the frame, thereby facilitating removal of the window pane 14 from the frame 16 as described further below. It should be appreciated that the layer 21 of polymeric material 20 may overlap the frame 16 provided that a suitable release agent or member is disposed over frame 16 to prevent the polymeric material 20 from bonding or adhering to the frame 16. Suitable release agents include petroleum based release agents, alcohols, aliphatic hydrocarbons, aromatic hydrocarbons, halogenated solvents, glycol ethers, methyl ethyl ketones, xylene, d-limonene, phthalates, and benzoates. Release members may include various types of mechanical barriers between the polymeric material and the frame 16. Of course, it is desirable that the release agent or member not be disposed over a significant portion of the glass pane 14 so that the surface area of pane 14 that is bonded to the polymeric material may be maximized.

It is preferred that the layer 21 cover each crack 18 in its entirety or substantially in its entirety. FIG. 2 illustrates the cracks 18 in their entireties covered by layer 21. In some cases, however, such as where a crack meets frame 16, it may not be feasible for the layer 21 to cover the crack in its entirety, such as due to the need to maintain a peripheral gap between the fame and the perimeter of the layer. Accordingly, the layer 21 should cover a substantial portion of the one or more cracks 18 and, preferably, should cover as much as possible of cracks 18.

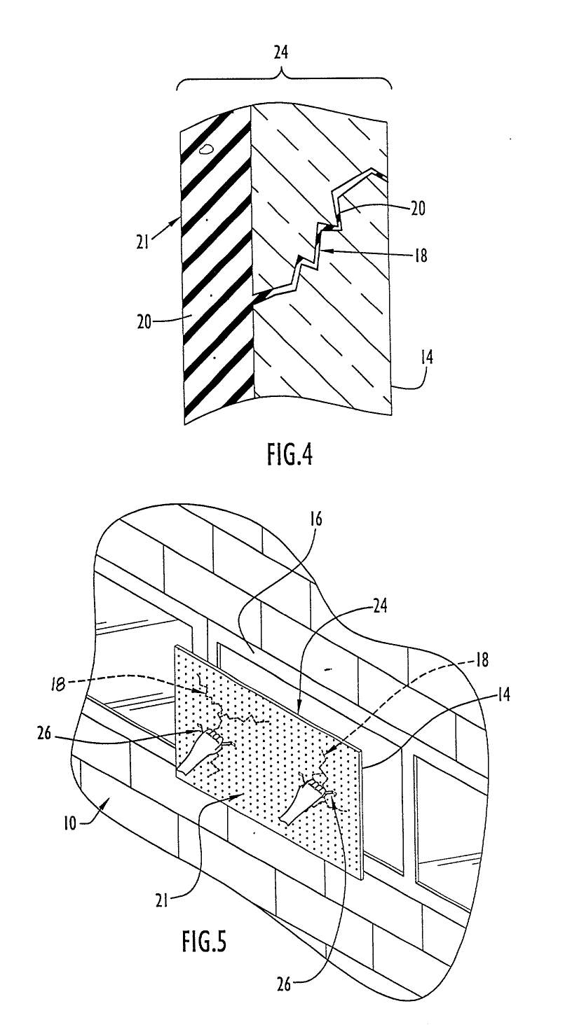

Subsequent to being applied to the window pane 14, the layer 21 of polymeric material 20 cures, dries, sets, hardens or solidifies quickly to form the shattered pane 14 into a cohesive, unified or integral mass 24 as shown in FIGS. 2 and 3. The layer 21 of polymeric material 20, when cured, is a solidified compressible material to which the window pane 14 including any individual fragments, such as fragment 19 and even the tiniest of fragments, are bonded or adhered. Where the polymeric material 20 has entered a crack 18 as shown in FIG. 4, a structural or mechanical bond is created at the crack when the polymeric material solidifies. In FIG. 4, the polymeric material 20 extends into the crack 18 from the exterior surface to the interior surface of window pane 14, and thusly extends the entire depth of the crack as well as the entire thickness of pane 14. However, the crack depth and pane thickness to which the polymeric material extends may vary in accordance with the crack width, the viscosity of the fluidic polymeric material and/or other factors. The polymeric material 20 is desirably very adhesive to ensure a strong bond with the window pane 14 so that the layer 21 of polymeric material 20 is permanently or substantially permanently bonded, adhered or attached to the window pane. Accordingly, the window pane does not become detached from the layer of polymeric material when extraneous forces are applied to the cohesive mass during removal from frame 16, disposal and/or while the cohesive mass is allowed to remain in place in frame 16 prior to removal. The strong bond between the layer of polymeric material and the window pane also allows the cohesive mass to be removed from frame 16 by pulling on the layer 21 as explained further below.

The polymeric material 20 may include a polyurethane with a propellant causing the polyurethane to foam upon application to the window pane so that the polymeric material remains in place as it is applied. FIG. 3 illustrates the polymeric material 20 as a polymeric foam material. Polymeric foams are generally very adhesive by nature and thus ensure adequate bonding to the window pane so that no fragments separate from the cohesive mass 24 during its removal. It should be appreciated, however, that the unifying material may be a non-foaming polymeric material, such as a non-foam polymeric film, as described further below. It should be further appreciated that the layer 21 can be pre-formed and then subsequently bonded or adhered to the window pane with a suitable adhesive or bonding agent. Various polymeric foams can be used in the present invention including those disclosed in applicant's U.S. patent application Ser. No. 09/362,890 filed Jul. 29, 1999, and pending U.S. patent application entitled Structures, Window Protection Systems and Methods for Protecting Glass Panes During Storms, filed Jun. 12, 2001, the disclosures of which are incorporated herein by reference. Examples of polymeric foam materials that may be utilized in the present invention include polyethylene, such as Ethafoam of Dow Chemical Company, polystyrene, polyurethane and copolymers of the foregoing.

Use of a polymeric foam for the unifying material results in a spongy, three-dimensional, compressible, elastomeric web pattern with open or closed cells or pores, sometimes containing entrapped gas for energy absorption. Accordingly, the layer 21 of polymeric material 20 can absorb energy from impacts sustained prior to, during, and subsequent to removal of the cohesive mass 24. In addition, the layer 21 of polymeric material 20 is deformable so as to allow the cohesive mass 24 to resiliently bend, flex, cave in or buckle along the relatively weaker areas defined by the one or more cracks 18, thereby facilitating removal of the cohesive mass from the window frame. The present invention is not limited to polymeric materials in that various non-polymeric materials capable of unifying a shattered window pane into a cohesive mass may be utilized as the unifying material.

In accordance with the present invention, one or more grasping members may be secured to the cohesive mass 24 for use in grasping the cohesive mass. FIG. 2 illustrates a pair of grasping members 26 secured to the cohesive mass 24 by the polymeric material 20, which acts as a bonding agent or adhesive for the grasping members. The grasping members 26 are formed as handles, respectively, each having opposing ends 28 embedded in the layer 21 of polymeric material 20 and an elongate grasping portion 30 extending between ends 28 as shown in FIGS. 2 and 3. The ends 28 may be embedded or pushed into the layer 21 of polymeric material 20 before it fully cures, with the grasping portion 30 maintained externally and free of the layer of polymeric material. If necessary, such as where the thickness of the layer 21 is insufficient to firmly secure the ends 28, additional polymeric material 20 may be added at the attachment sites for ends 28 to increase the thickness and, therefore, the securing strength, of the polymeric material at the attachment sites. When the polymeric material 20 has finally cured, the ends 28 will be bonded or adhered to the polymeric material, and the grasping members 26 will be secured to the cohesive mass 24.

The handles can be made of any suitable material including plastic, metal, cardboard and paper. Where additional unifying material is applied to the layer 21 for securement of the grasping members, the additional polymeric material can be applied before and/or after the layer 21 has finally cured. Also, the layer 21 and the additionally applied polymeric material can be used individually or in combination to secure the grasping members to the cohesive mass in that the handle ends can be embedded or inserted in the layer 21 and/or in the additionally applied polymeric material. The grasping members 26 formed as handles can be cut or fabricated to have a desired length such that the length of the handles is adjustable. The length of the handles may also be adjusted by controlling the length of ends 28 that is embedded in the polymeric material. By allowing the grasping members 26 to be attached in situ, the optimal locations for the grasping members can be selected in accordance with variables such as location of the window structure, accessibility of the window structure and size and configuration of the window pane. Where the layer of polymeric material is pre-formed and not formed in situ, grasping members can be attached thereto in situ or during the layer formation process. The grasping members can be secured to the cohesive mass in various ways including the use of other adhesives or bonding agents and/or mechanical fasteners such as clips.

The polymeric material 20 may be supplied as a one-component supply system, as shown by FIG. 1, or a two-component supply system, as explained further below. In the one-component supply system of FIG. 1, mixing takes place in a tank or container 34 of spraying device 22, which has a discharge device or nozzle 36 for spraying or discharging the fluidic polymeric material from the container 34. As an example of a one-component supply system, container 34 contains a polymeric blend such as a polymeric/polyol, polyurethane prepolymer and a polymeric hydrocarbon propellant to be delivered as a foam from delivery device 36.

Once the polymeric material 20 applied to window pane 14 has cured sufficiently, which may occur within a few minutes after application, the window structure 12 may be considered stabilized in that formation of the shattered pane 14 into cohesive mass 24 restores structural integrity and sealing functionality to the window pane. The window pane 14 will then be in condition for safe removal as one piece or as a plurality of relatively large pieces of cohesive mass 24. However, since the window structure 12 is stabilized, the window pane 14 does not have to be removed immediately but can remain in place until a suitable replacement pane and/or convenient time for replacement is/are available. The polymeric material 20 is water-repellant and resistant to degradation or damage from environmental elements and can remain exposed to weather conditions such as rain, snow, sun and wind. While the window pane 14 remains in place, the window pane as well as people and objects disposed to the exterior and/or the interior sides of the window structure are protected from injury and damage. In particular, collapsing or caving in of the window pane is inhibited, glass fragments and shards such as fragment 19 are bonded or embedded in the polymeric material and cannot become loose, and the passage of environmental elements through the glass pane is deterred.

The window pane 14 may be safely removed to the exterior of building 10 by pulling the cohesive mass 24 in the exterior direction from the frame 16 as shown in FIG. 5, wherein the cohesive mass is manually pulled via hands holding grasping members 26. As the cohesive mass 24 is pulled, it may resiliently flex, bend, deform or cave in, as needed, along the relatively weakened areas of the cohesive mass presented at cracks 18 to permit disengagement of the window pane 14 from frame 16. If necessary, the cohesive mass 24 may be hit adjacent to frame16 with a hammer or other tool, or a tool may be inserted between the edge of the window pane 14 and the frame 16, to disengage the edge of window pane 14 from the frame 16. As shown in FIG. 5, the cohesive mass 24, including the layer 21 of polymeric material 20 and the window pane 14 bonded thereto, may be removed as a single, integral and unitary piece. However, the cohesive mass 24 may be removed as a plurality of relatively large, integral and unitary pieces, with each piece including a section of the layer 21 and a corresponding section of window pane 14 attached thereto. In either case, the window pane remains attached to the layer of polymeric material during and subsequent to removal such that glass fragments or shards do not become separated or detached. Where it is desired to remove the window pane as more than one piece of cohesive mass 24, such as where the window pane is too large to remove as one piece, the cohesive mass may be cut into a plurality of pieces prior to removal. The cohesive mass 24 may be cut into a plurality of pieces by cutting the layer 21 of polymeric material 20 along one or more of the cracks or fissures of the window pane 14, and each piece of the cohesive mass may be associated with one or more grasping member. When the cohesive mass 24 is removed from frame 16 as shown in FIG. 5, the cohesive mass will remain as a single, integral unit during transport to a disposal site. Similarly, where the cohesive mass is removed as more than one piece, each piece will remain intact as a single, integral unit.

Although the cohesive mass 24 is shown herein as being removed to the exterior of the window structure by a single, exteriorly located person pulling the cohesive mass in the exterior direction, it should be appreciated that the cohesive mass can be removed to the exterior or to the interior of the window structure as one or more pieces by one or more persons in various ways, such as by pulling and/or pushing the cohesive mass, with or without the use of grasping members. Pulling and/or pushing of the cohesive mass can be performed using the hands or various conventional tools. Subsequent to being removed from the window frame 12 and the fabrication or construction, i.e. building 10, the cohesive mass 24 including window pane 14 thereof can be safely handled and transported to a disposal site.

FIG. 6 illustrates a stabilized window structure 112, similar to window structure 12, including a layer 121 of non-foam unifying material 120 applied to the exterior surface of a broken window pane 114. The window pane 114 is mounted in frame 116 and has cracks 118 therein. The layer 121 of polymeric material 120 may be applied, such as by spraying, to window pane 114 in fluidic form as described above and, upon drying, curing, hardening or setting of the polymeric material 120, a cohesive mass 124 is formed including the layer 121 of polymeric material 120 and the window pane 114 adhered thereto. Illustrative non-foam materials, which may be polymers or non-polymers, suitable for use in the present invention include cellulosic and polymer films such as polyvinyl, latex, polyurethane, acrylate, cellophane and other polymers, and cellulosics or composites.

A stabilized window structure 212 in which first and second layers 221 and 221′ of polymeric material 220 have been applied to both the exterior and interior surfaces, respectively, of window pane 214 having cracks 218 therein is shown in FIG. 7. Each layer 221 and 221′ is made up of multiple sub-layers or coats of polymeric material 220 as shown by first and second sub-layers 221a and 221b for layer 221 and sub-layers 221a′ and 221b′ for layer 221′. The sub-layers for each layer 221 and 221′ may be applied sequentially, one on top of the other, after at least partial curing of the underlying sub-layer. Applying layers 221 and 221′ of polymeric material to both the exterior and interior surfaces of window pane 214 enhances the seal and structural integrity provided by the cohesive mass 224, which includes window pane 214 and layers 221 and 221′ adhered thereto. More particularly, the shattered window pane 214 is sealed between the layers 221 and 221′, and the layers 221 and 221′ provide additional assurance that glass fragments will not become detached during removal and transport of the cohesive mass 224. Although the layers 221 and 221′ are illustrated as being similar to layer 21, it should be appreciated that layers of polymeric material similar to layer 121 can be applied to the exterior and interior surfaces, respectively, of a shattered window pane. As shown by dotted lines for layer 221, the layer of polymeric material may be of non-uniform or varying thickness.

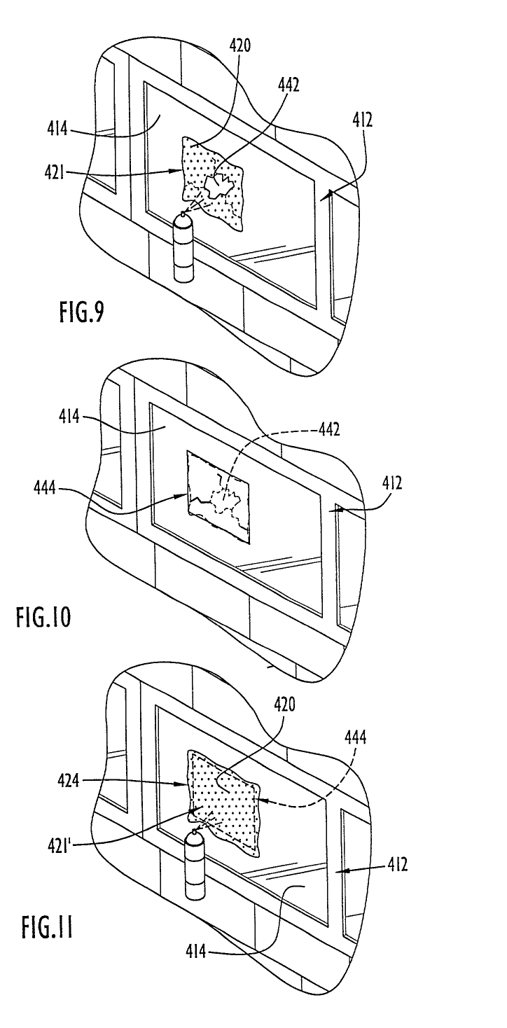

A two-component supply system for use in the present invention is illustrated in FIG. 8. The two-component supply system includes a first supply tank or container 334a containing component A, such as a polymeric polyol, a second supply tank or container 334b containing component B, such as disocyanate, and a mixing head 338 which statically blends and reacts components A and B under pressure from a propellant 340 for delivery of polymeric material 320 in fluidic form through delivery device or nozzle 336. The disocyanate and the polymeric polymer are mixed under the propellant's pressure and sprayed onto a shattered window pane 314. Foaming will start as soon as the polymeric blend is deposited on the window pane 314, and a desired polymeric foam thickness may be achieved. As noted above, additional sub-layers or coats can be applied for extra protection. A catalyst can be added to the supply system if it is desired to decrease curing time. The one-component supply system of FIG. 1 is similar with the exception that a higher viscosity polyurethane prepolymer is used that is moisture cured by atmospheric humidity. An example of a two-component supply system is the Froth-Pak system of Flexible Products Company of Marietta, Ga.

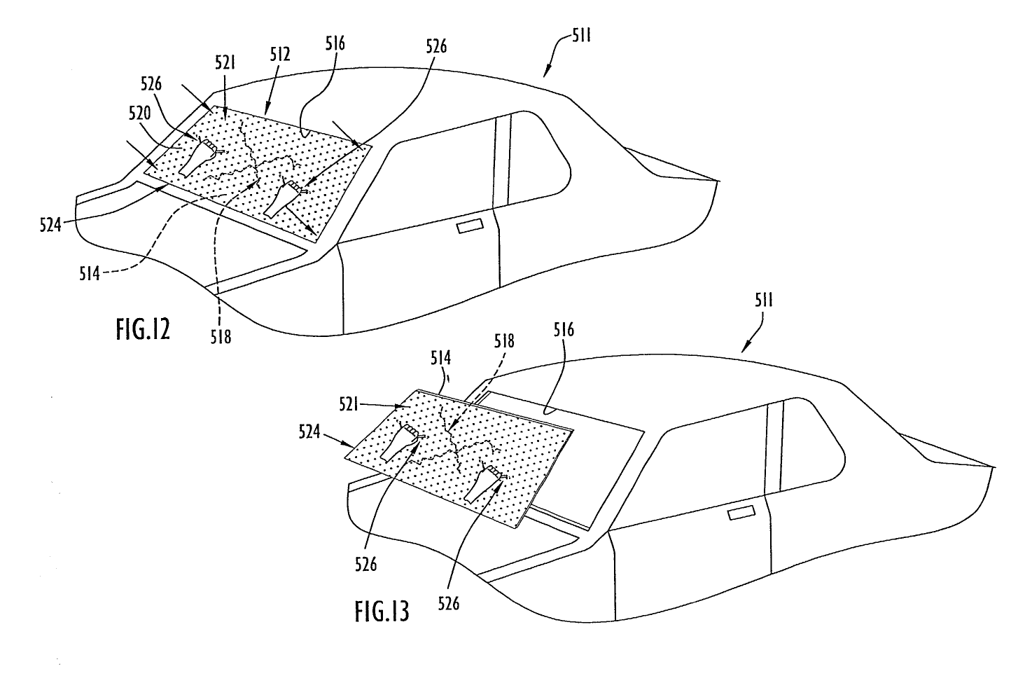

FIGS. 9-11 illustrate a procedure for stabilizing a window structure 412 having a shattered window pane 414 that is missing one or more fragments. As a result of the one or more missing fragments, window pane 414 has a hole, opening or void 442 therein. In accordance with the present invention, a first layer 421 of polymeric or cellulosic unifying material 420 is applied to the exterior or interior surface of window pane 414 around the perimeter of hole 442 as shown in FIG. 9, which illustrates the first layer 421 of polymeric or cellulosic material 420 being sprayed onto the exterior surface of window pane 414. A patch 444, larger than the hole 442, is positioned over the hole 442 and is adhered to the polymeric or cellulosic material as shown in FIG. 10. The patch 444 will bond to the polymeric or cellulosic material around the perimeter of hole 442 and thusly close off the hole 442. Once the layer 421 of polymeric or cellulosic material 420 has cured sufficiently so that the patch 444 is bonded, adhered or secured to the window pane 414, a second or additional layer of polymeric or cellulosic unifying material 421′ is applied over the patch, as shown in FIG. 11, to provide structural integrity and a seal for the hole 442. The second layer 421′ bonds to the first layer 421, to the patch 444 and to the window pane 414 to form a cohesive mass. Preferably, the second layer 421′ of polymeric or cellulosic material is applied to an area larger than the patch 444 so that the edges of the patch are covered and thereby sealed. The seal provided by the additional layer 421′ of polymeric or cellulosic material deters the entry of water and other environmental elements through the hole 442. The patch 444 may be cut to size during use and may be made of any suitable material including cotton and synthetic fabrics, plastics and paper. Of course, a layer of polymeric or cellulosic unifying material may also be applied to the interior surface of the window pane 414 for additional protection.

An automobile 511 having a window structure 512 stabilized in accordance with the present invention is illustrated in FIG. 12. Window structure 512 includes a frame 516 and a shattered windshield 514 of non-planar configuration mounted in frame 516; however, the present invention is applicable to various fixed and slidable or other movable windows in vehicles. The present invention is useful for stabilizing and removing shattered vehicle windows in emergency and non-emergency situations, but is particularly useful in emergency situations where a vehicle window must be quickly removed to access one or more passengers in the interior of the vehicle without pushing glass fragments into the interior and causing injury to the one or more passengers. As shown in FIG. 12, a layer 521 of polymeric unifying material 520 is applied to the exterior surface of windshield 514 over cracks 518 and forms cohesive mass 524 including the shattered windshield 514 and the layer 521 adhered thereto. In FIG. 12, the layer 521 of polymeric material 520 is shown applied to the entire exterior surface of windshield 514 exposed by frame 516, with the layer 521 conforming to the curvature of the windshield 514. Also, grasping members 526 in the form of handles have been secured to cohesive mass 524.

To remove shattered windshield 514, the grasping members 526 are grasped from the exterior of automobile 511, and the cohesive mass 524 is pulled in the exterior direction as shown in FIG. 13. The cracks 518 in windshield 514 permit the cohesive mass 524 to resiliently deform, buckle, cave in, bend or flex along the relatively weaker areas defined by cracks 518 so that the windshield 514 is disengaged from the frame 516. If the windshield 514 is not cracked or shattered sufficiently to permit the cohesive mass 524 to deform to the extent necessary to disengage the windshield from frame 516, the windshield can be held substantially in place by one or more persons via grasping members 526 while one or more other persons apply a force to the edges of the windshield in the interior direction, as shown by arrows in FIG. 12. The force applied to the edges of the windshield 514 may be applied using a window punch or another suitable tool, and an interiorly directed force may be applied to the edges of the windshield at various locations adjacent frame 516 as shown by the arrows of FIG. 12. In this way, the edge of windshield 514 may be disengaged from the frame 516, but the windshield is prevented from falling into the automobile interior by the exteriorly directed counter force applied via grasping members 526.

The present invention may be used to stabilize and/or remove window panes in buildings, vehicles and other fabrications or constructions. The present invention may be used on planar and non-planar window panes of various types of window structures. In accordance with the present invention, a shattered, broken or cracked window pane is bonded with a layer of unifying material into a cohesive, integral mass which can be controllably removed from a window frame as one or more integral and unitary pieces. The layer of unifying material quickly bonds or adheres to the window pane, such that the window pane is stabilized and may be removed shortly after the layer of unifying material is applied. The relatively quick cure time for the unifying material makes the present invention particularly well suited for stabilizing and/or removing window panes in time critical situations. Holes, openings or voids in window panes can be covered and sealed in accordance with the present invention, with or without the use of a patch. However, a patch may be useful for closing off and sealing relatively large holes which would be difficult to fill with the polymeric material alone. The layer of unifying material may be pre-formed or may be formed in situ as a result of applying the unifying material to the window pane. The layer of unifying material is resistant to environmental elements and, if desired, may be safely left in place for some time after application to the window pane. Removal of a window pane in accordance with the present invention ensures that fragments of the window pane remain attached to the cohesive mass and are not separated or scattered during removal and disposal. Accordingly, the need to collect and dispose of may scattered pieces of the window pane is eliminated. Even where the cohesive mass is removed as a plurality of relatively large pieces, the pieces are not injurious due to their large size and the protection provided by the layer of unifying material.

What is claimed is:

1. A stabilized window structure comprising
a window frame;
a shattered window pane disposed in said window frame and having an exterior surface and an interior surface exposed by said window frame; and
a layer of unifying material bonded to at least one of said exterior surface or said interior surface, said layer of unifying material and said window pane bonded thereto forming an integral, cohesive mass removable from said window frame as one or more integral and unitary pieces.

2. A stabilized window structure as recited in claim 1 wherein said window pane is planar.

3. A stabilized window structure as recited in claim 1 wherein said window pane is non-planar.

4. A stabilized window structure as recited in claim 1 wherein said window frame is disposed in a building.

5. A stabilized window structure as recited in claim 1 wherein said window frame is disposed in a vehicle.

6. A stabilized window structure as recited in claim 1wherein said unifying material is a polymeric material.

7. A stabilized window structure as recited in claim 6 wherein said polymeric material is a polymeric foam.

8. A stabilized window structure as recited in claim 7 wherein said polymeric foam includes a polyurethane.

9. A stabilized window structure as recited in claim 7 wherein said polymeric foam includes a polyethylene.

10. A stabilized window structure as recited in claim 7 wherein said polymeric foam includes a polystyrene.

11. A stabilized window structure as recited in claim 6 wherein said polymeric material is a polymeric film.

12. A stabilized window structure as recited in claim 11 wherein said polymeric film includes a polyvinyl.

13. A stabilized window structure as recited in claim 11 wherein said polymeric film includes a latex.

14. A stabilized window structure as recited in claim 11 wherein said polymeric film includes a polyurethane.

15. A stabilized window structure as recited in claim 11 wherein said polymeric film includes an acrylate.

16. A stabilized window structure as recited in claim 11 wherein said polymeric film includes a cellophane.

17. A stabilized window structure as recited in claim 1 wherein said unifying material is a cellulosic material.

18. A stabilized window structure as recited in claim 1 wherein said layer of unifying material is applied to said window pane in fluidic form and cures to form said cohesive mass.

19. A stabilized window structure as recited in claim 18 wherein said window pane includes a crack therein and said unifying material seeps into said crack when said unifying material is applied in fluidic form and forms a structural bond at said crack when said unifying material cures.

20. A stabilized window structure as recited in claim 1 and further including at least one grasping member secured to said cohesive mass.

21. A stabilized window structure as recited in claim 20 wherein said at least one grasping member includes a handle bonded to said layer of unifying material.

22. A stabilized window structure as recited in claim 1 wherein said layer of unifying material is disposed over substantially the entirety of said at least one of said exterior surface or said interior surface.

23. A stabilized window structure as recited in claim 1 wherein said layer of unifying material includes a plurality of individual sub-layers arranged one on top of the other.

24. A stabilized window structure as recited in claim 1 wherein said layer of unifying material includes a first layer of unifying material bonded to said exterior surface and further including a second layer of unifying material bonded to said interior surface, said first and second layers of unifying material and said window pane bonded thereto forming said cohesive mass.

25. A stabilized window structure comprising
a window frame;
a window pane disposed in said window frame and having a hole therein and an exterior surface and an interior surface exposed by said window frame;
a first layer of unifying material adhered to at least one of said exterior surface or said interior surface around said hole;
a patch covering said hole and being adhered to said first layer of unifying material; and
a second layer of unifying material applied over said patch and forming a cohesive mass with said patch, said first layer of unifying material and said window pane.

26. A stabilized window structure as recited in claim 25 wherein said patch has a periphery and said second layer of unifying material covers at least said periphery of said patch.

27. A stabilized window structure as recited in claim 26 wherein said patch has a surface area and said second layer of unifying material covers said surface area in its entirety.

28. A method of stabilizing and removing a shattered window pane from a window frame, said method comprising the steps of
applying a layer of unifying material to at least one of an exterior surface or an interior surface of the shattered window pane;
bonding the layer of unifying material to the window pane to form a cohesive mass including the window pane and the layer of unifying material; and
removing the cohesive mass from the window frame as one or more integral and unitary pieces.

29. A method of stabilizing and removing a shattered window pane as recited in claim 28 wherein said step of applying includes spraying the unifying material in fluidic form onto the at least one of the exterior surface or the interior surface of the window pane and said step of bonding includes allowing the unifying material to dry.

30. A method of stabilizing and removing a shattered window pane as recited in claim 28 wherein said step of applying includes applying a polymeric foam material the window pane.

31. A method of stabilizing and removing a shattered window pane as recited in claim 28 wherein said step of applying includes applying a polymeric film material to the window pane.

32. A method of stabilizing and removing a shattered window pane as recited in claim 28 wherein said step of applying includes applying a cellulosic material to the window pane.

33. A method of stabilizing and removing a shattered window pane as recited in claim 28 wherein said step of applying includes applying the layer of unifying material as a plurality of sub-layers sequentially applied one on top of the other.

34. A method of stabilizing and removing a shattered window pane as recited in claim 28 wherein said step of applying includes applying a first layer of unifying material to the exterior surface of the window pane and further including, prior to said step of removing, the steps of applying a second layer of unifying material to the interior surface of the window pane and bonding the second layer of unifying material to the window pane to form the cohesive mass including the window pane and the first and second layers of unifying material.

35. A method of stabilizing and removing a shattered window pane as recited in claim 28 wherein said step of applying includes applying the layer of unifying material to substantially the entirety of the at least one of the exterior surface or the interior surface.

36. A method of stabilizing and removing a shattered window pane as recited in claim 28 and further including, prior to said step of removing, the step of attaching at least one grasping member to the cohesive mass.

37. A method of stabilizing and removing a shattered window pane as recited in claim 36 wherein said step of applying includes applying the unifying material in fluidic form, said step of bonding includes allowing the unifying material to cure and said step of attaching includes inserting a portion of the at least one grasping member into the unifying material prior to curing thereof such that the portion of the at least one grasping member is bonded to the unifying material when the unifying material has cured.

38. A method of stabilizing and removing a shattered window pane as recited in claim 36 wherein said step of removing includes manually pulling the cohesive mass away from the window frame via the at least one grasping member.

39. A method of stabilizing and removing a shattered window pane as recited in claim 28 wherein said step of removing includes removing the cohesive mass as a single piece.

40. A method of stabilizing a window pane having a hole therein, said method comprising the steps of
applying a first layer of unifying material to at least one of an exterior surface or an interior surface of the window pane around the hole;
positioning a patch over the at least one of the exterior surface or the interior surface of the window pane such that the patch covers the hole and contacts the first layer of unifying material;
bonding the first layer of unifying material to the window pane and the patch;
applying a second layer of unifying material over at least the periphery of the patch; and
bonding the second layer of unifying material to the patch such that the hole is closed off and sealed.

41. A method of stabilizing a window pane as recited in claim 40 wherein said step of applying a second layer includes applying the second layer of unifying material to the at least one of the exterior surface or the interior surface so as to cover the patch in its entirety.
